(19) United States
(12) Patent Application Publication
(10) Pub. No.: US 2008/0067470 A1
(43) Pub. Date: Mar. 20, 2008

(54) Methods and Solid Compositions for Generating Soapy and Non-Soapy Aqueous Solutions Containing Free Chlorine Dioxide

(75) Inventors: John Appadurai Thangaraj, Edison, NJ (US); Lakkaraju Dasaradhi, Princeton Junction, NJ (US)

Correspondence Address: DEMONT & BREYER, LLC, 100 COMMONS WAY, Ste. 250, HOLMDEL, NJ, 07733, US

(73) Assignee: SIPKA INC., Edison, NJ (US)

(21) Appl. No.: 11/854,434

(22) Filed: Sep. 12, 2007

Related U.S. Application Data
(60) Provisional application No. 60/825,718, filed on Sep. 15, 2006.

(51) Int. Cl. C09K 3/00

(52) U.S. Cl. 252/187.21

(57) ABSTRACT

Some embodiments of the invention provide solid compositions that, when exposed to or otherwise placed in an aqueous solution, will release chlorine dioxide and surfactants, producing a soapy, aqueous solution containing chlorine dioxide. These solid compositions comprise an alkali chlorite salt, a solid acid source, and a surfactant. In some other embodiments, the solid compositions produce a non-soapy aqueous solution containing chlorine dioxide. These solid compositions comprise an alkali chlorite salt and a solid acid source.

### STATEMENT OF RELATED CASES

This case claims priority of U.S. Patent Application Ser. No. 60/825,718, filed Sep. 15, 2006 and which is incorporated herein by reference.

### FIELD OF THE INVENTION

The present invention relates generally to the chlorine dioxide, and more particularly to methods and solid compositions for generating solutions containing free chlorine dioxide.

### BACKGROUND OF THE INVENTION

Chlorine dioxide (ClO₂) is a gas molecule and is highly soluble in water. It is used in a variety of applications, including, for example: as a pulp bleaching agent, a bactericide, a viricide, an algaecide, a fungicide, and a selective oxidizer. Chlorine dioxide is an effective antimicrobial even at very low concentrations and over a wide range of pH.

Chlorine dioxide is typically produced commercially from aqueous solutions of chlorite-containing salts. See, e.g., U.S. Pat. No. 5,009,875 and Ullmann's Encyclopedia of Industrial Chemistry, vol. A 6, p. 496-500. Various agents are used to generate or release chlorine dioxide. See, e.g., U.S. Pats. Nos. 2,309,457, 2,043,284 4,019,983, 4,013,761, 4,806,215, 4,129,484 4,247,531, 6,967,010, 5,478,446, 5,258,171, and 6,967,010.

Due to its inherent instability and explosive nature, chlorine dioxide is generally not transported; it is usually produced on-site at the time of use. Due to the instability issue, much attention has been focused on the development of stabilized chlorine dioxide products. These products typically provide a sodium chlorine dioxide solution having a pH that is adjusted to 7.0 so that there is no release of chlorine dioxide. To release chlorine dioxide, pH is lowered to provide an acidic environment.

A stabilized chlorine dioxide aqueous solution is disclosed as a germicide for use in cheese production in U.S. Pat. No. 3,147,124. A stabilized aqueous chlorine dioxide is also disclosed in U.S. Pat. Nos. 4,296,102 and 3,123,521 for killing microorganisms in water.

U.S. Pat. No. 5,324,447 discloses the use of tablet activator and stabilized chloride dioxide product, which is now sold under the trademark Puregene® by Bio-cide International Inc. and used for disinfecting contact lenses. U.S. Pat. No. 5,719,100 discloses the production of chlorine dioxide in an aqueous solution from a tablet comprising a composition of sodium chlorite and an acid activator, wherein the composition requires a reaction-preventing barrier between the sodium chlorite and acid component.

U.S. Pat. No. 6,238,643 discloses different methods for producing an aqueous solution of chlorine dioxide by reacting a metal chlorite and an acid-forming component. The reactants are very stable and do not react to produce chlorine dioxide when water is substantially absent. Before use, the reactants are separated from liquid water by a membrane. The membrane permits controlled passage of liquid water and/or water vapor. Chlorine dioxide is generated when water passes through the membrane. The chlorine dioxide that is generated passes out through the membrane into liquid water to produce the desired aqueous chlorine dioxide solution.

Tablets, etc., for rapidly and safely preparing highly-converted solutions of chlorine dioxide are disclosed in U.S. Pats. Nos. 6,432,322 and 6,699,404. The tablets comprise a sodium chlorite, dry solid acid sources, desiccating filling agents such as calcium chloride and magnesium chloride, a dichlorocyanuric acid, and its sodium salt (NaDCC) to enhance the yield of chlorine dioxide.

U.S. Pat. No. 4,073,888 discloses that certain quaternary ammonium salts are effective when used with chlorine dioxide. For example, an aqueous liquid consisting of a mixture of stabilized chlorine dioxide solution and didecyl dimethyl ammonium chloride can be used for hard-surface cold sanitization and sterilization.

U.S. Pat. No. 4,889,654 discloses the generation of aqueous disinfectant foam solutions containing an organic foam-generating agent, typically a surfactant, and chlorine dioxide foam using surfactants and sodium hydroxide in water containing chlorine-dioxide solution.

Notwithstanding the aforementioned developments, issues remain regarding the safety and convenience of products and methods for generating chlorine dioxide.

### SUMMARY OF THE INVENTION

Some embodiments of the invention provide solid compositions that, when exposed to or otherwise placed in an aqueous solution, will release chlorine dioxide and surfactants, producing a chlorine dioxide soap solution. The resulting solution is very stable. In particular, open containers of chlorine dioxide soap solution that are produced in accordance with the invention have been stable (i.e., more than 50 percent of the initially released chlorine dioxide remains in solution) for 3 weeks or more and closed containers have been stable for about 5 weeks.

The amounts of the solid composition and the aqueous medium are varied to produce an application-specific amount of chlorine dioxide in solution. Generally, chlorine dioxide soap solutions generated by the methods described herein have a chlorine dioxide content within the range of about 0.1 parts per million (ppm) to about 5000 ppm by weight and a surfactant concentration in the range of from 0.0 to about 90% by weight in the solution. Of course, an even lower concentration of chlorine dioxide can be obtained by dilution.

Unlike some prior-art chlorine-dioxide solutions, chlorine-dioxide containing solutions described herein can have a pH that is in the range of between about 1 to 9.

In some of the embodiments disclosed herein, solid compositions including a surfactant (soap) and chlorine-dioxide release materials are compressed into a tablet. Placing the tablet in water causes the release of a high concentration of chlorine dioxide as well as surfactant, thereby forming an aqueous soapy solution containing chlorine dioxide.

In some other embodiments, a powder or granular form of the solid composition is used to generate chlorine dioxide soap solution. In some embodiments, the powder or granules are used “loose;” in other words, they are simply sprinkled into water. In some other embodiments, the powder or granules are placed in a sachet or other water-permeable housing (e.g., capsule, pouches, etc.).

It is unexpected and surprising that the loose powdered or granular forms of the composition are as effective as tablets for generating chlorine dioxide. In particular, prior work had shown that there is generally little or no chlorine dioxide formed when a powder form of a chlorine dioxide generator is rapidly dissolved in water. (See, e.g., U.S. Pat. No. 6,699,404 at col. 6, lines 49-51; U.S. Pat. No. 6,432,322 at col. 4, lines 15-19.) It has been discovered that by adding a polyacrylate, or forms thereof (e.g., partial acid salts, etc.), to the solid composition, a substantial amount of chlorine dioxide can be generated from loose powder or granules.

In some embodiments, polyacrylate-containing solid compositions do not include a surfactant. As a consequence, some embodiments of the present invention provide a loose powder or granular preparation that, when exposed to or otherwise placed in water, will generate an aqueous solution of chlorine dioxide that does not contain soap. As previously indicated, in the prior art, powder or granular preparations for generating chlorine dioxide were known to be substantially ineffective for producing chlorine dioxide unless the powder/granules were retained in a sachet or other water-permeable barrier that provided a controlled exposure to water. The use of polyacrylate and forms thereof in the solid compositions disclosed herein dispenses with that requirement.

In some other embodiments, polyacrylate-containing solid compositions include a surfactant. Such compositions will provide a loose powder or granular preparation that, when exposed to or otherwise placed in water, will generate a soapy, aqueous solution of chlorine dioxide.

The solid compositions described herein are very stable in dry conditions. That is, they release chlorine dioxide and surfactants only when exposed to or otherwise placed in an aqueous solution. Calcium and magnesium salts are not recommended for use as desiccators in the solid composition since they add to the hardness of water and reduce soap properties.

The high stability of the chlorine dioxide soap solutions described herein is believed to be due to the presence of certain surfactants and, to a lesser extent, other ingredients of the composition. It has also been observed that chlorine dioxide is even retained on the surface to which it has been applied (e.g., during cleaning, etc.) for a longer period of time in the presence of a surfactant(s). The stability of the chlorine dioxide soap solution varies as a function of surfactant type as well as other ingredients in the composition.

Some embodiments of the present invention provide a safe means of generating and using chlorine dioxide soap solution, such as can be used in a wide variety of applications, particularly those in which antimicrobial activity and cleansing activity are required or otherwise desired for disinfecting and cleaning hard surfaces. And the solutions disclosed herein are particularly efficacious in view of the fact that they maintain antimicrobial activity (arising from the solubilized chlorine dioxide) for weeks instead of minutes or hours. Some illustrative applications for the chlorine dioxide soap solutions described herein include, without limitation:
Antimicrobial hand-wash soap for hospitals, public places and in home;
Solutions for cleaning and sterilizing medical equipment;
For use in dishwashers (commercial and consumer);
For use in sanitizing and cleaning clothing;
As a stain remover for clothing, carpets, and the like;
Disinfectant cleaner for floors in hospitals, homes, public buildings, industrial facilities and commercial places (e.g., restaurants, movie theaters, etc.);
Bathroom cleaner (floor, toilet bowel, and toilet water-tank cleaner);
Toilet deodorizer cake;
Food, meat and vegetable contact-surface cleaner (counter top, cutting board, etc.)
Teat dip sanitizer;
Denture and mouth wash cleaning;
In Foot/Nail sanitizer SPA solution;
Ostomy bag sanitizer;
Cleaning/antimicrobial solution for animals (e.g., in veterinary hospitals, pet shampoo, etc.);
Contact lens cleaning solution;
Hair salon disinfectant for equipment (e.g., combs, scissors, manicure tools, etc.);
For use in acne patches;
Pharmaceutical therapeutics; and
Bio-terror-related antimicrobial product (e.g., for preventing Anthrax cross-contamination via contact surfaces, including skin).

### DETAILED DESCRIPTION

When exposed to water, the solid compositions disclosed herein generate aqueous soapy solutions containing chlorine dioxide. In the illustrative embodiment, chlorine dioxide is generated by exposing an alkaline chlorite salt and an acid activator, which are contained in the solid composition, to water. For example:
NaClO₂+H⁺→ClO₂ [1]

A solid composition in accordance with the illustrative embodiment comprises: chlorine dioxide release materials and one or more surfactants for cleansing.

Chlorine dioxide release materials include an alkali chlorite salt and solid acids. Suitable alkali chlorite salts include, without limitation, sodium chlorite, potassium chlorite, and lithium chlorite. Suitable solid acids include, without limitation, citric acid, mono and di-sodium citrate, sodium hydrogen sulfate, sodium di-hydrogen and mono-hydrogen phosphates, tetra-sodium etidronate (tetra-sodium (1-hydroxyethylidene) bisphosphates, poly(acrylic acid) partial sodium salt, poly(acrylic acid) partial potassium salt, and acid-impregnated inorganic solids.

As will be understood by those skilled in the art in view of this specification, a relatively high yield of chlorine dioxide is obtained from a solid composition that has a relatively greater amount of acid and a relatively lesser amount of alkali chlorite salt. Conversely, a relatively low yield of chlorine dioxide is obtained from a solid composition that has a relatively lesser amount of acid and a relatively greater amount of alkali chlorite salt. For example, a solid composition comprising five (5) weight percent of sodium chlorite and forty (40) weight percent of acid will generate far more chlorine dioxide than a solid composition comprising seventy (70) weight percent of sodium chlorite and twenty (20) weight percent of acid.

Suitable surfactants include those that do not react with chlorine dioxide or interfere with its release. In fact, both anionic and non-ionic surfactants are suitable for use in conjunction with the illustrative embodiment of the invention. Anionic surfactants suitable for use include, without limitation, SLS (sodium dodecyl sulfate), sodium laureth sulfate, alkyl sulfonates such as 1-pentane sulfonic acid sodium salt monohydrate, 1-hexane sulfonic acid sodium salt monohydrate, 1-heptane sulfonic acid sodium salt monohydrate, 1-octane sulfonic acid sodium salt, 1-decane sulfonic acid sodium salt, sodium dodecyl benzene sulfonate, linear alkyl benzene sulfonate, sodium alkyl naphthalene sulfonate. Anionic surfactants are generally suitable for use in the solid compositions disclosed herein because, for the most part, they do not react with chlorine dioxide or interfere with its release.

Suitable non-ionic surfactants include alkyl poly (ethylene oxide), and more specifically polyethylene oxide. Cationic and zwitterionic surfactants are also suitable for use in conjunction with the illustrative embodiment of the present invention.

Anionic, non-ionic, and cationic surfactants that include nitrogen-containing compounds, such as amines, ammonia, quaternary ammonium salts, or urea, are generally not suitable for use in conjunction with the illustrative embodiment. The reason is that these compounds readily react with chlorine dioxide, interfere with its release, or otherwise reduce its concentration. Coloring agents, dyes and fragrances are also not recommended for use in the solid compositions disclosed herein because they rapidly react with chlorine dioxide.

In some embodiments, any one or more of fillers, disintegrates for tablet formulations, thickeners, and/or foaming agents are also incorporated in the solid compositions disclosed herein. These agents are used for any of a variety of purposes, including, without limitation: to enhance the release of chlorine dioxide, and/or to enhance the soap qualities of the solution, and/or to facilitate tabletting, and/or enhance disintegration of tablets. Examples of these additional agents include, without limitation: hydroxy methyl, ethyl and propyl cellulose and methocel E15 premium (hypromellose 2910), microcrystalline cellulose, providone, poly vinyl pyrrolidione, poly plasodone cross povidone, sodium polyacrylate, magnesium stearate, sodium hydrogen carbonate, sodium carbonate, sodium chloride and sodium acetate. The purpose(s) for some of these agents are described briefly below.

In the solid compositions disclosed herein, methylcellulose provides one or more of the following functions:
(i) as a diluent for the sodium chlorites and solid acids to avoid premature release of chlorine dioxide;
(ii) as a binder for pressing tablets;
(iii) to control the access of water (for reaction) to the chloride dioxide releasing agents in the solid composition, thereby increasing the amount of chlorine dioxide released; and
(iv) to slow the rate of disintegration of tablets.

In the solid compositions disclosed herein, sodium polyacrylate provides one or more of the following functions:
(i) as a desiccant to avoid premature release of chlorine dioxide;
(ii) to control the access of water (for reaction) to the chlorine dioxide releasing agents in the solid composition, thereby increasing the amount of chlorine dioxide released; and
(iii) as a thickener for soap.

For the illustrative embodiment, the solid compositions are prepared as follows. All ingredients are individually crushed to granular or powder form, dried at a temperature that is in the range of about 80° C. to about 120° C. for a length of time that is in the range of about 2 to about 10 hours, and then cooled to room temperature. An appropriate amount of ingredients are mixed in a sealed container using a rotator roller mixer. In some embodiments, the resulting powder or granules can be introduced into a sachet or other water-permeable housing, such as pouches, capsules, or the like. In some other embodiments, the powder or granules is not placed in a water-permeable housing; rather, it is left “as is.” In yet further embodiments, the powder or granules can be formed into a tablet using a laboratory tablet press.

In order to generate a high concentration of chlorine dioxide, exposure of the solid acid and alkaline chlorite salt reactants should take place in a controlled (i.e., gradual) manner. In the absence of controlled exposure, there is a very low rate of chlorine dioxide release. For example, it has been observed in the prior art that when a powdered or a granular preparation of a chlorine dioxide generator is placed in the water, relatively little chlorine dioxide is generated. This is because of the (immediate) availability of the water and the relatively large surface area of powdered or granular formulations.

In some embodiments, controlled exposure to water is achieved by providing the solid compositions described herein in a tablet form, or as powders/granules in a sachet or other water permeable housings (e.g., capsules, pouches, etc.) that limit water access.

In some other embodiments, controlled exposure is achieved by one or more additive(s) that, at least functionally, create a barrier between the solid composition and the water. In embodiments in which the solid compositions include such additive(s), powered or granular preparations can be directly introduced into water; that is, a sachet, etc., is not required. Polyacrylates, and forms thereof, are an example of an additive that provides this functionality. A partial listing of suitable polyacrylates include, for example, sodium polyacrylate, poly acrylic acid partial sodium salt, poly (acrylic acid), partial sodium salt-graft-poly(ethylene oxide), poly acrylic acid partial potassium salt, and potassium polyacrylate.

In a further embodiment, the solid compositions disclosed herein for forming chlorine-dioxide containing soap solutions can be implemented as a two-component system.

One of the two components, which is embodied as a tablet, powder, granules, etc., contains constituents for generating chlorine dioxide. In some embodiments, the chlorine-dioxide generating component includes chlorine dioxide release materials, as disclosed above (e.g., an alkali chlorite salt and a solid acid), as well as methyl cellulose (e.g., Methocel E15 methyl cellulose) and sodium polyacrylate.

The second of the two components, which is embodied as a tablet, powder, granules, etc., is a soap-generating composition. The soap-generating component includes, for example, anionic surfactant (e.g., about 25%), nonionic surfactant (e.g., about 20%), sodium hydrogen carbonate (e.g., about 15%), Methocel methyl cellulose or microcrystalline cellulose (e.g., about 15%), dibasic sodium phosphate (e.g., about 10%), tripolyphosphate (e.g., 10%), and trisodium citrate (e.g., 5%).

In some embodiments, the two components have the same physical form; that is, both being tablets, or both powders, etc. In some further embodiments, the physical forms of the two components are different. That is, in some embodiments, the first component is embodied as a tablet, while the second component is in the form of powder or granules. In some other embodiments, the first component is in the form of powder or granules while the second component is in tablet form.

In embodiments of a chlorine-dioxide generating solid composition in accordance with the illustrative embodiment of the invention, key constituents will be present in the solid composition in an amount falling within the following ranges:

| | |
|---|---|
| alkali chlorite salt: | about 1 to about 80 weight percent |
| acid: | about 2 to about 90 weight percent |
| surfactants: | 0 to about 70 weight percent |
| cellulose: | 0 to about 50 weight percent |
| polyacrylate: | 0 to about 50 weight percent |
| (or forms thereof) | |

### EXAMPLES

The dried chemical compositions listed below in Table 1 were prepared as described above and then pressed into 8 millimeter tablets. Tablets were prepared to contain either 500 mg or 1000 mg of the solid composition. An individual tablet or loose powder was placed in a flask containing an appropriate quantity of water to generate an aqueous soapy solution containing chlorine dioxide (for Examples 1-7). The solutions were diluted to appropriate concentrations and analyzed by an HP 8452A diode array spectrophotometer at 360 nm. The chlorine dioxide in solution was quantitated using the standard chlorine dioxide solution absorbance. The presence of surfactant does not interfere with the chlorine dioxide absorbance at 360 nm.

TABLE 1
Chemical Composition in Weight Percent

| CONSTITUENTS | EX 1 | EX 2 | EX 3A/B | EX 4 | EX 5 | EX 6 | EX 7 | EX 8 | EX 9A/B |
|---|---|---|---|---|---|---|---|---|---|
| Sodium Chlorite | 30% | 36% | 30% | 30% | 20% | 30% | 30% | 35% | 28% |
| Citric Acid | 40% | 40% | 40% | — | — | — | — | 49% | — |
| Methocel E15 | 10% | — | 10% | 10% | 10% | 10% | — | 11% | 8% |
| Premium/Hydroxy | | | | | | | | | |
| methyl cellulose | | | | | | | | | |
| SLS Sodium | 10% | 15% | 10% | 10% | 30% | — | 10% | — | 10% |
| Dodecyl Sulfate | | | | | | | | | |
| Magnesium | 1% | 1% | 1% | 1% | 10% | 1% | — | — | — |
| Stearate | | | | | | | | | |
| Sodium hydrogen | 4% | 3% | — | 9% | — | — | — | — | — |
| carbonate | | | | | | | | | |
| Mono-sodium | 5% | 5% | — | — | — | — | — | — | 30% |
| hydrogen | | | | | | | | | |
| phosphate | | | | | | | | | |
| Sodium | — | — | 9% | — | — | 9% | 20% | 5% | 5% |
| polyacrylate | | | | | | | | | |
| Sodium hydrogen | — | — | — | 40% | 30% | 40% | 40% | — | — |
| sulfate | | | | | | | | | |
| Polyethylene oxide | — | — | — | — | — | 10% | — | — | |
| Cross Povidone | — | — | — | — | — | — | — | — | 5% |
| Trisodium citrate | — | — | — | — | — | — | — | — | 10% |
| Di-sodium | — | — | — | — | — | — | — | — | 4% |
| hydrogen | | | | | | | | | |
| phosphate | | | | | | | | | |

### Example 1

One 500 mg tablet was placed in one liter of water and after 20 minutes the tablet was completely dissolved. A clear, yellow-green aqueous soap solution was formed. The solution had 47 ppm of free chlorine dioxide. The pH of the solution was 3.8. The solution was stable for 3 weeks in open container and stable for 5 weeks in a closed container.

### Example 2

Methocel E15 premium/hydroxy methylcellulose 30% solution in methanol (100 ml) was mixed with 160 g of sodium chlorite. The methanol was evaporated, the mixture was dried at 80° C. for 4 hours, and cooled to room temperature. The resulting methylcellulose-coated sodium chlorite was then crushed to powder. The methylcellulose-coated sodium chlorite was mixed with the other constituents. One 500 mg tablet formed from this solid composition generated about 26 ppm of chlorine dioxide in a one liter of soap solution.

### Example 3A

In this example, sodium polyacrylate was used as a thickener. One 500 mg tablet was placed in one liter of water and generated about 36 ppm of free chlorine dioxide in a soap solution.

### Example 3B

Using the same solid composition as Example 3A, 500 mg of free powder (not pressed into a tablet or contained in a water-permeable housing) generated about 29 ppm chlorine dioxide in 3-5 minutes in one liter of soap solution.

### Example 4

In this example, sodium hydrogen sulfate was used as the acid source. One 500 mg tablet placed in one liter of water produced a soapy solution containing 48 ppm of free chlorine dioxide. The pH of the solution was 5.8.

### Example 5

In this example, the surfactant concentration was increased from 10% to 30%. The resulting one-liter soapy solution contained 31 ppm of free chlorine dioxide. This example demonstrates that tripling surfactant concentration has no adverse affect on the release of chlorine dioxide. It is notable that the concentration of sodium chlorite (the chlorine dioxide release component) in this example was only 20%, down from 30%. Reducing sodium chlorite concentration will cause a decrease chlorine dioxide release.

### Example 6

In this example, the anionic surfactant was replaced with a non-ionic surfactant: polyethylene oxide. A one thousand milligram tablet generated 38 ppm of free chlorine dioxide in a one-liter soapy solution. (The polyethylene oxide was not dried for use.)

### Example 7

In this example, sodium polyacrylate was increased to 20% (compare examples 3A/3B and 6 at 9%). The solid composition was not pressed into a tablet. Rather, the powder, sans water-permeable housing, was used. One thousand mg of powder or granules generated about 136 ppm of chlorine dioxide in 200 ml of water.

### Example 8

For this example, surfactant is excluded from the solid chlorine-dioxide forming composition. As a consequence, the resulting chlorine-dioxide containing solution is not soapy. The solid composition was not pressed into a tablet; rather, as in Example 7, the powder, sans water-permeable housing, was added directly water. One thousand mg of powder generated about 46 ppm of chlorine dioxide in 1 liter of water.

### Example 9A

In this example, cross povidone is used as a disintegrant to facilitate dissolution of, for example, a tablet preparation. Tri-sodium citrate is used to help buffer the solution above a pH of 5. Additionally, trisodium citrate can serve to provide a citrus flavor/odor without affecting the generation of chlorine dioxide. Like tri-sodium citrate, di-sodium hydrogen phosphate functions to buffer the solutions above a pH of 5. Both mono- and di-sodium hydrogen phosphate help to keep glassware clean (prevents or decreases the incidence of salt deposition (removes Ca and Mg from surfaces). Although the generation of chlorine dioxide is not affected by the presence of cross povidone or tri-sodium citrate, the presence of phosphates does reduce chlorine dioxide generation by about 5 to 10 percent.

For Example 9A, a tablet was formed from the listed composition. One 500 mg tablet was placed in one liter of water and generated about 51 ppm of free chlorine dioxide.

### Example 9B

Using the same solid composition as Example 9A, 500 mg of free powder was added directly to one liter of water and released 42 ppm of free chlorine dioxide.

In an alternative embodiment, polyacrylate serves as the acid activator, in addition to its role in controlling the access of water to the alkali chlorite salt. An alternative formulation of a solid composition useful for forming soap solutions containing chlorine dioxide and using a polyacrylate as the acid activator includes, for example: chlorine-dioxide releasing agents (e.g., sodium chlorite, poly(acrylic acid) partial sodium salt) methocel E15 methyl cellulose, and surfactant (e.g., SLS Sodium Dodecyl Sulfate, etc.). A solid composition for generating non-soapy aqueous solutions containing chlorine dioxide comprise, for example: chlorine-dioxide releasing agents (e.g., sodium chlorite, poly(acrylic acid) partial sodium salt) and methocel E15 methyl cellulose.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. Reference throughout the specification to “one embodiment” or “an embodiment” or “some embodiments” means that a particular constituent, feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular constituents, features, structures, materials, or characteristics can be combined in any suitable manner in one or more embodiments. It is therefore intended that such variations be included within the scope of the following claims and their equivalents.

What is claimed:

1. A solid composition comprising an alkali chlorite salt in an amount in a range of about 1 to 80 weight percent, a solid acid source in an amount in a range of about 2 to 90 weight percent, and a surfactant in an amount in a range of about 0 to 70 weight percent.

2. The solid composition of claim 1 wherein said surfactant is anionic.

3. The solid composition of claim 1 wherein said surfactant is non-ionic.

4. The solid composition of claim 1 wherein said surfactant is selected from the group consisting of cationic compounds and zwitterionic compounds.

5. The solid composition of claim 1 further comprising a disintegrant in an amount up to and including about twenty weight percent based on the solid composition, wherein said disintegrant is selected from the group consisting of poly vinyl pyrrolidone and poly plasdone cross povidone.

6. The solid composition of claim 1 wherein said surfactant does not contain nitrogen.

7. The solid composition of claim 1 further comprising a cellulose-based compound.

8. The solid composition of claim 1 further comprising a polyacrylate.

9. The solid composition of claim 1 wherein said solid acid source is selected from the group consisting of poly(acrylic acid) partial sodium salt or poly(acrylic acid) partial potassium salt.

10. The solid composition of claim 1 wherein said solid composition comprise two separate components:
(a) a chlorine-dioxide generating component, which is embodied in a form selected from the group consisting of a tablet, a powder, and granules; and
(b) a soap-generating component, which is embodied in a form selected from the group consisting of a tablet, a powder, and granules.

11. A solid composition comprising an alkali chlorite salt in an amount in a range of about 1 to 80 weight percent, a solid acid source in an amount in a range of about 2 to 90 weight percent, and an acrylate in an amount in a range of about 0 to 50 weight percent.

12. A solid composition comprising an alkali chlorite salt in an amount in a range of about 1 to 80 weight percent and an acid in an amount in a range of about 2 to 90 weight percent, wherein the acid is selected from the group consisting of poly(acrylic acid) partial sodium salt and poly(acrylic acid) partial potassium salt.

13. A method for forming an aqueous soapy solution containing free chlorine dioxide, wherein the method comprises:
(i) forming a solid composition comprising an alkali chlorite salt, a solid acid source, and a surfactant; and
(ii) exposing said solid composition to water.

14. The method of claim 13 wherein the operation of forming a solid composition further comprises forming a powder from said solid composition.

15. The method of claim 13 wherein said solid composition further comprises a polyacrylate.

16. The method of claim 13 wherein a pH of said aqueous soapy solution is adjusted to a value between about 1 to about 9.

17. The method of claim 13 wherein a free chlorine dioxide concentration in said aqueous soapy solution is within a range of about 0.1 ppm to about 5000 ppm by weight.

18. A method for forming an aqueous soapy solution containing free chlorine dioxide, wherein the method comprises:
(i) forming a first solid composition for releasing chlorine dioxide, wherein said first solid composition comprises an alkali chlorite salt and a solid acid source;
(ii) forming a second solid composition for forming a soap solution, wherein said second solid composition comprises a surfactant; and
(iii) exposing said first solid composition and said second solid composition to water.

19. The method of claim 18 wherein said first solid composition further comprises a polyacrylate.

20. The method of claim 18 wherein said solid acid source is selected from the group consisting of poly(acrylic acid) partial sodium salt and poly(acrylic acid) partial potassium salt.

21. The method of claim 18 wherein said second solid composition further comprises a polyacrylate.

22. A method for sanitizing and cleaning an environment, comprising:
(i) forming an aqueous soapy solution containing free chlorine dioxide by exposing a solid composition comprising an alkali chlorite salt, a solid acid source, and a surfactant to water; and
(ii) applying or exposing said environment to said aqueous soapy solution.

23. The method of claim 22 wherein said environment is a hard surface.

24. The method of claim 23 wherein said hard surface is selected from the group consisting of a floor, a wall, surfaces of a toilet, surfaces of a sink, medical utensils, grooming utensils, eating utensils, cooking utensils, drinking glasses, counter tops, contact lenses, and dentures.

25. The method of claim 22 wherein said environment is mammalian skin.
